(19) United States
(12) Patent Application Publication
(10) Pub. No.: US 2021/0233364 A1
(43) Pub. Date: Jul. 29, 2021

(54) REAL-TIME, LIVE SIMULCAST ONLINE CARD GAME

(71) Applicant: Cash Live Entertainment Inc., Vancouver (CA)

(72) Inventors: Matthew JARVIS, White Rock (CA); Samarth CHANDOLA, Vancouver (CA)

(21) Appl. No.: 17/159,314

(22) Filed: Jan. 27, 2021

Related U.S. Application Data
(60) Provisional application No. 62/966,096, filed on Jan. 27, 2020.

(51) Int. Cl. G07F 17/32

(52) U.S. Cl. CPC G07F 17/3276; G07F 17/3293; G07F 17/3223

(57) ABSTRACT

A real-time, live simulcast online card game has a remote game server connecting a live host with a plurality of players interested in playing the game. The game server assigns each player to one of a plurality of game players and assigns community cards which are visible and applicable to each player across all of the game tables. The game server then assigns player cards to each player which are only visible and applicable to the player. Players with the best combination of cards using their own player cards in combination with the community cards are determined winners of each round, with the winners of each round advancing to a subsequent round, until one winner is determined after three rounds of game play.

### FIELD

Embodiments of this invention relate to online games, and more particularly relate to live, simulcast online card games featuring a live host hosting a single game to a plurality of players worldwide.

### BACKGROUND

Online games are increasingly becoming a more common form of entertainment, allowing individual players to engage or participate in games for several hours. The most common type of online games are simply games that one can download or play directly through an online interface. Such simple games usually pits the player against him/herself, allowing the player to challenge themselves by improving their game play. A very common game of this type is the online version of Solitaire.

One advancement from this simple type of game play is where the individual player plays against an opponent, whether the opponent is an actual individual or a computer. An example of such a game is the online version of Chess, where one player can play against another, or the player can choose to play against a computer. In situations where the player chooses to player against another individual player, the game is necessarily played simultaneously.

Recent advances in artificial intelligence permits players from around the world to form teams and play directly against other teams. Such games allow for live communication between the players of each team and a server having artificial intelligence programming allows the players of each team to coordinate and collaborate to achieve a common goal. An example of such a type of game is commonly known as PUBG. In this instance, players can download the application onto a mobile device and simultaneously play the game with players from around the world.

Advancements in artificial intelligence allows games to be played simultaneously with players from all around the world. This increases a player's game play experience by increasing the player pool, as well as allowing a player to play against or with players of similar skills or allows a player to challenge himself or herself by playing against a player of greater skill or knowledge.

For example, HQ's Trivia game features a host, hosting a single game of trivia pursuit involving a plurality of players from all over the world. The host would show a single card containing a trivia question for all of the players simultaneously and would provide a time period for each player to answer the question. After being showed the common question card, each player must submit his/her answer within the time period allotted. Players providing the wrong answer are eliminated from the game, while players providing the correct answer are permitted to continue. Unfortunately, this particular game is limited in the sense that only a single game can be played at any one time, as the host or dealing provides live commentary on the game. The game is limited to a single game as the host can only provide live commentary to a single game.

Online gaming, and in particular online card or casino games, are also now becoming a more common form of entertainment. In some variations of online card games, in order to attract players and to increase a player's game experience, the games are capable of being adapted to permit individual gamers or participants to obtain or win awards, such as points, game tokens or even cash. In certain types of online games, individual players are permitted to wager on their own likelihood of success in the game.

For example, an online poker game, from PokerStars.net, provides a multitude of games that can be played simultaneously. Each game can comprise a host or dealer (also known as the house) that hosts the game for a plurality of players. Most commonly, a total number of players for each game is usually limited, and players from one particular game cannot play against a player from another ongoing game. The disadvantage of this type of game play is that does not permit a plurality of players to all play against one another in a single game that is hosted by a common host.

### SUMMARY

Generally, a real-time, live simulcast online card game comprises a variation of well known card games using a number of a typical deck of cards having 52 cards. A remote game server can be connected to other servers, including a commentator or host for hosting the online card game of choice. This card game of choice is then broadcast live and in real-time to all the players participating in the card game, and any spectators thereof, having a live host providing real-time, live commentary on the game as the game progresses.

In a broad aspect of the invention, a system for operating a real-time, live simulcast online card game has a remote game server that is adapted to store and then carrying out instructions on how to play the online game. The remote game server is remotely connected to a live host via the internet, and also remotely connected to a plurality of external player devices to allow a plurality of players from across the world to participate in the online card game. In an embodiment, the live host is provided with real-time game play information and real-time player information to allow the host to give live and simultaneously commentary as the online card game progresses, giving each of the plurality of players an interactive gaming experience.

In another broad aspect of the invention, a real-time, simulcast online card game can comprise the steps of: 1) a game server connecting to a live host or commentator; 2) having a plurality of players submitting a request to the game server to participate in the card game; 3) the game server reviewing and accepting each of the plurality of players' requests for participation; 4) the game server calculating a total number of players and determining a total number of a plurality of game tables required to accommodate all the players accepted; 5) randomly assigning each of the plurality of players to one of the plurality of game tables; 6) and beginning or initiating game play.

### BRIEF DESCRIPTION OF THE DRAWINGS

FIG. 1a is a schematic diagram illustrating an embodiment of the present invention, showing a single game having a plurality of game tables, with each game table having a plurality of players in a first round of game play;

FIG. 1b is a schematic diagram illustrating the embodiment in accordance with FIG. 1a, showing a second round of game play, with the winners of the first round advancing into the second round;

FIG. 1c is a schematic diagram illustrating the embodiment in accordance with FIG. 1b, showing a final round of game play, with the winners of the second round advancing into the final round;

FIG. 2 is a schematic diagram of an embodiment of the present invention, illustrating a remote game server operatively connecting a host to a plurality of players through external player devices;

FIG. 3 is a table illustrating an embodiment of the present invention, the table showing the steps involved to initiate a real-time, live simulcast online card game; and

FIG. 4 is a table illustrating an embodiment of the present invention, the table showing the steps involved for a three round game.

### DETAILED DESCRIPTION

Embodiments of the present invention relate to a live, simulcast online card game hosted by a live-streamed dealer, host or otherwise a commentator, and more particularly to a card game using playing cards and involving a plurality of game tables and a plurality of players.

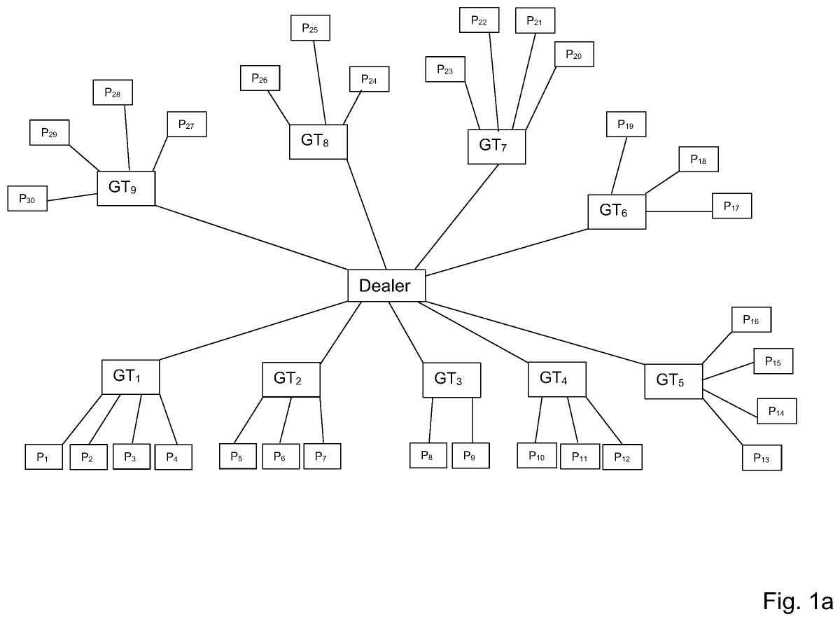

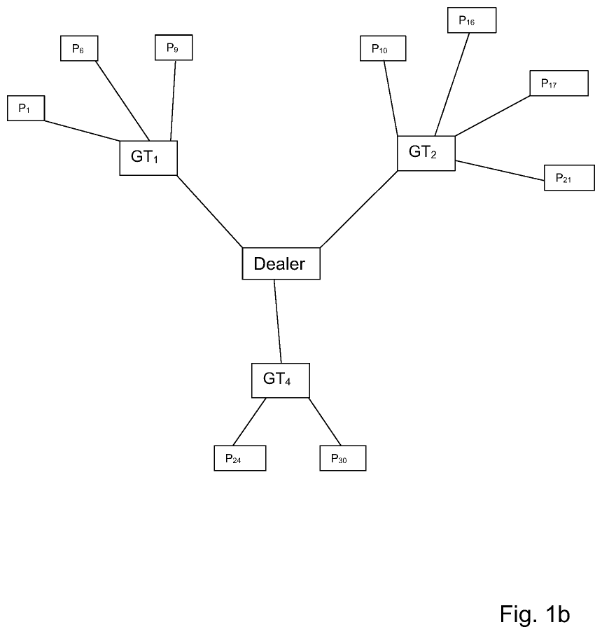

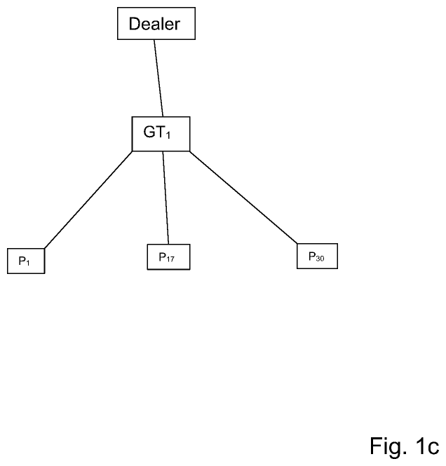

With reference to FIG. 1, in a typical online card game, a game can comprise a live-streamed host or commentator (not shown) operating or hosting the game. Each game can comprise a plurality of game tables GT (e.g. GT₁, GT₂, GT₃, GT₄, GT₅ . . . ), with each game table comprising a plurality of players P (e.g. P₁, P₂, P₃, P₄, P₅ . . . ).

As shown, each game table is not limited to a certain number of players and can vary depending on the total number of players that desire to participate.

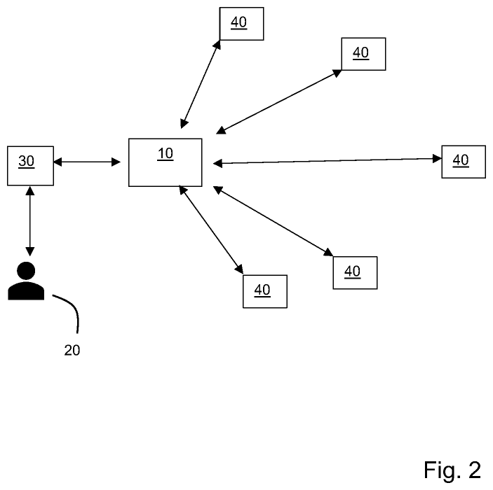

With reference to FIG. 2, in operation, prior to commencing the real-time, live simulcast online card game, a remote game server 10 can remotely connect to a live host or commentator 20 via an external commentator device 30. The external commentator device 30 can include audio and video equipment for displaying game statistics provided by the game server 10 and for broadcasting a live video and audio stream to the remote game server 10. In embodiments, the commentator 20 can be an actor portraying a role of a casino host or hostess based on real-time information provided to the host 20 to provide an interactive experience to each of the plurality of players of the game.

The remote game server 10 can also be remotely connected to a plurality of external player devices 40 from which a plurality of players (P₁, P₂, P₃, P₄, P₅, etc.) can participate or play in the game.

In embodiments, the game server 10 can have at least memory for storing and carrying out instructions on how to operate the online card game. The game server 10 can also have at least a database for storing real-time game play information and player information, which can be made readily accessible and available for the host 20 to access to provide live commentary thereon simultaneously during game play. In other embodiments, the database can also store historical game plays and historical player information.

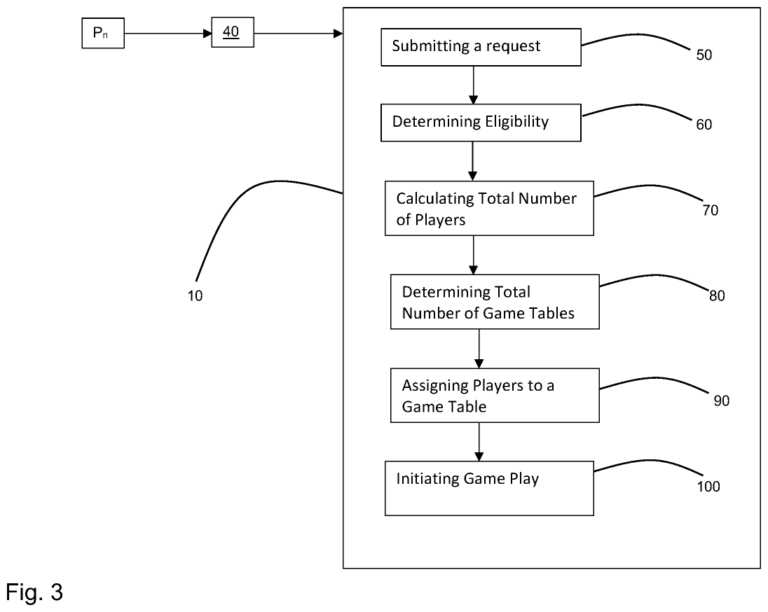

With reference to FIG. 3, if a player decides to participate in a game, the interested player Pₙ can submit a request 50 through their external player device 40 to indicate player's Pₙ interest in participating in the game, and the game server 10 can then determine if the interested player Pₙ is eligible for game play 60 by either accept or deny the interested player's request to play. The decision to either accept or deny a request can be based upon a number of different criteria, which can depend on the type of game being played. For example, in an embodiment, if the game is an online casino game, a request can be denied if an interested player does not have sufficient game credits or tokens to play. In another example, an interested player can be denied if the interested player has a prior history or record of inappropriate behavior during game play (i.e. use of foul language or non-compliance with any terms or conditions set forth to participate in a game). In embodiments, such historical player information can be stored on a database or other forms of computer memory. During this period of accepting requests by interested players to play the game, the host 20 can be providing live commentary to encourage and otherwise entertain an audience and players by remotely accessing historical game play information or real-time player information stored on the database, or by being provided this information by the game server 10.

After a plurality of players are accepted for participating in a game, the game server 10 calculates the total number of participating players 70 and determines a total number of a plurality of game tables 80 suitable to accommodate all of the plurality of players accepted. Upon determining a total number of a plurality of game tables, the game server randomly assigns each of the plurality of players to one of the plurality of game tables 90.

Once all of the players are assigned to a game table, the game server 10 notifies the host 20 through the commentator device 30 that the game and a first round of the game is about to commence. The notice can be in the form of either an audio or visual signal, or a combination of both. The host 20 can take cue from the notice and provide appropriate live commentary.

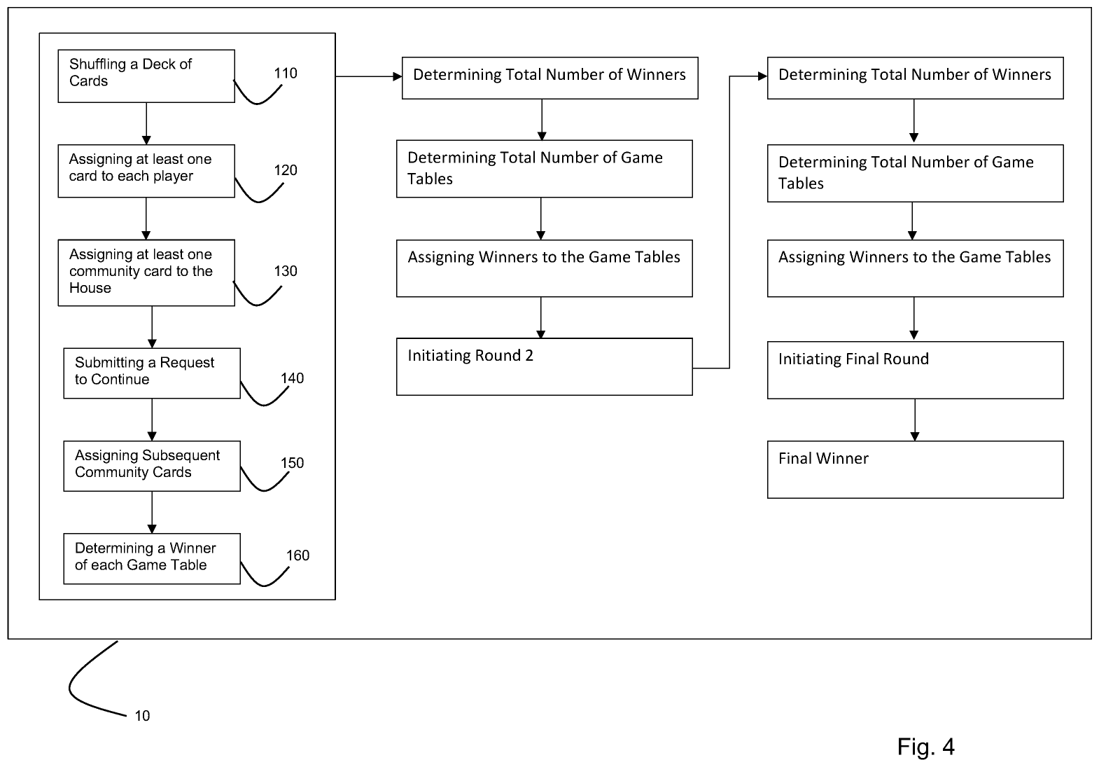

With reference to FIG. 4, a first round of game play (Round 1) for all of the game tables can be initiated 100 by the game server 10. In the first round of game play, for each game table, the game server 10 shuffles a deck of cards 110 and assigns at least one card to each player at the game table 120. The assigned player cards are only visible to that individual player the card is assigned to, and not visible to any other player at the assigned game table. Players at different game tables can receive or can be assigned cards that are different than the players at another game table. In embodiments, the assigned player cards of a player at one game table can be the same as the assigned player cards of a player at a different game table. In an embodiment, the at least one assigned card can be visible and applicable only to its respective player. The game server 10 then assigns at least one community card to the house 130. In embodiments, the at least one assigned community card can be visible and applicable to all of the plurality of players across all game tables. In another embodiment the at least one assigned community card can be visible but not applicable to all of the players. In another embodiment, the at least one assigned community card can be visible to the players but applicable to the house.

As the at least one community card is assigned and dealt, the host 20 can be simultaneously provided with updates or real-time game play information to allow the host 20 to provide live commentary on the community cards.

After the at least one community card is assigned to the house, each player at each game table must decide if they wish to continue with the round, or to simply withdraw from the initial first round. A decision to continue with the game play in the first round requires each player to submit a request to continue 140 to the game server 10. The game server 10 receives all of the requests to continue to play and determines which players have opted out of continued game play in the first round. The game server 10 then updates the display for each player at each game table to indicate which players at that particular game table are still involved in the round and which players are not.

In embodiments, each external player device 40 can comprise a monitor or display to visually show game play in real-time. In embodiments, the game server 10 through a processor, is able to recognize each player and the player's associated external player device 40 to only show the real-time game play of the game table that the player has been assigned to. In embodiments, if a player opts out of continuing game play, then the game server 10 can continue to show real-time game play of the player's assigned game table on the player's associated external player device 40.

Following each players' decision to continue or not to continue to play, the game server assigns one or more subsequent community cards to all remaining players 150. As with the initial at least one assigned community cards, the one or more subsequent community cards may be visible to all players, and/or may be applicable to all players. As the one or more subsequent community cards are assigned, the game server 10 simultaneously updates and notifies the commentator of the one or more subsequent community cards. Upon assignment of the one or more subsequent community cards, and upon receipt of the updates from the game server 10, the commentator 20 can provide live comments thereon.

As the commentator 20 is providing live comments, or concurrently with the live comments, the game server 10 determines a winner from each game table 160 for the first round. Concurrently, the game server 10 determines overall game statistics, and overall player standings, provides the commentator 20 notice thereof, and allows the commentator 20 to live stream comments to all the players across all game tables.

It is important to note that the community cards assigned to the house are visible and applicable to all the players across all of the game tables.

Once a winner is determined for the first round, a subsequent round (or second round) of game play for each game table is initiated. In preparation for the second round, the game server 10 calculates the total number of winners or winning players from each game table in the first round, determines a total number of game tables required to accommodate all of the winners of the first round, and then randomly assigns each of the winners of the first round to one of the plurality of game tables in the second round. The second round, then, follows the same steps as the first round, such that the game server shuffles a deck 110, at least one card is assigned to each player 120, at least one community card is assigned to the house 130, the commentator 20 provides live commentary regarding the community card, each player determines if they wish to continue or discontinue play by submitting a request to continue 140, the game server 10 determines which players wish to continue and which player wishes to discontinue and assigns subsequent community cards to the house, assigning subsequent community cards 150 followed by live commentary from the commentator 20 on the community cards. Then the game server 10 determines a winner 160 for the second round for each game table.

A third subsequent round of game play is initiated and played in the same fashion. In embodiments, further subsequent rounds of game play can be initiated before a final game play round is initiated. In other embodiments, this third round can be the final round. As discussed above, the total number of game plays can be determined by the game server 10, depending on the total number of winners from the second round.

After completion of each game play round, the game server 10 analyzes and determines a number of players (or winners of the previous round) that would be eligible to participate in a subsequent round of game play. This continues until a final round of game play. In embodiments, the final round of game play can be the third round.

The final round of game play is played in a similar fashion until a final winner is determined. However, the final round or game play is enhanced by live commentary by the commentator 20 regarding not only the community cards assigned to the house, but also commentary on the cards assigned to each player in the final round of game play.

### For Example—Poker

At the beginning of a real-time and live, simulcast online game of poker (in this particular instance, a version of Texas Hold'em), a remote game server 10 hosting an appropriate application and carrying out instructions stored on memory, can remotely connect with a live commentator or host 20. In certain embodiments, the live commentator 20 can be located in a particular country, for example, the United States, and speak a language common to the country, for example English. In other embodiments, the commentator 20 can be located in any country and be able to fluently speak a language common to players, such as English. In certain embodiments, the commentator 20 can be speaking English (or any other language) and the host's live comments can be simultaneously broadcasted in a different language via a translation service. With reference to FIG. 2, the host 20 can be connected to the game server 10 via the internet and an external device 30 for use by the commentator 10.

As shown in FIG. 3, in order for a potential player to participate in the real-time, live simulcast online game of poker, each player (for example P₁) must first submit a request to the remote game server 10 using their own external device 40, such as a home computer, handheld mobile device, etc. As each potential player (P₁, P₂, P₃, P₄, etc.) submits their requests via the internet, the game server 10 receives the requests and determines if the requesting player is eligible for game play. The game server 10 can review a digital signature or history of a player and determine if the request from the interested player should be accepted. In embodiments, the digital signature or history of a player can be stored on a database of the game server 10. Acceptance of a player can depend upon a variety of pre-determined criteria.

After all players have been accepted by the game server 10, the game server 10 determines a total number of players desiring to participate in the online game. Once the server 10 determines the total number of players, the server 10 determines an appropriate number of game tables and randomly assigns each of the plurality of players to one of the plurality of game tables. Once each player is assigned a game table, the online game is ready to begin.

Once each player is assigned to a game table, the game server 10 provides statistical information about each player to the host 20, allowing the host 20 to provide comments, such as the player's game name, and possible game history and other player information. The live host 20 can then provide simultaneous and live commentary on the progress of the game.

The game begins with a first round of game play. For each game table, the game server 10 shuffles a deck of playing cards and provides or otherwise assigns each player with two cards known as hole cards (player assigned player cards). These two assigned player or hole cards are only visible to the player to whom they are assigned and cannot be seen by any other player. Once the hole cards are assigned, the server or dealer then deals three community cards known as flop cards. The three flop cards are assigned to the house and are visible and applicable to each of the plurality of players across all game tables. The server, during game play is continually providing real-time and live updates to the host 20 to provide real-time comments on the game as it progresses. At this point of the game play, the commentator 20 can comment on the flop cards or assigned community cards.

After the flop, each player is provided a period of time to decide if they wish to continue or discontinue or otherwise fold. If the player wishes to continue, he or she will submit a request to the game server 10 to continue. After receiving all of the requests to continue, the game server 10 will provide an update on players who have folded and will then proceed to assign a subsequent community card, or commonly known as the turn card. The turn card is assigned to the house, and is visible to all players and shared or otherwise applicable to all players remaining in the game. The commentator 20 can provide live comments on the turn card simultaneously and in real-time.

The game server 10 will then follow up by assigning a second subsequent community card, known as the river card, to the house. The river card is visible to all remaining players and applicable to all.

After the river card is assigned, the game server 10 determines a winner for the first round of game play by comparing the hands held by each player for each game table. The server 10 uses the player cards assigned to each player in combination with the flop cards, the turn card and the river card assigned to the house, all the while the commentator 20 is providing real-time comments.

Subsequent second and third rounds can be commenced and completed to determine game round winners. After the second round, the game server analyzes and determines which players are eligible for game in the final round.

The final round can be operated in a similar fashion.

In embodiments, to enhance the interactive experience for a player or an audience member, the Applicant envisions that the game can incorporate the following features: 1) Spectator features, such as providing players who have opted out of continued game play, with something to do while they watch a game, for example, vote on winning hands, cheer on a friend/follow table, switch tables, view table friend is on and follow them through etc.; 2) Invite features button where players will be presented with the information on how Invite Friends works and possibly an associated reward; 3) Friending Feature, which allows the players to connect with players to chat, send gifts, review stats, etc.; 4) Stats Feature, which can include metrics such as best place, largest prize, lifetime winnings, winning hands percentage, etc.; 5) a Leaderboard feature showing screens that displays the players ordered by winnings on several categories, such as current week, and all time. In embodiments, a sub-filter can enable users to be able to additionally select additional filters based on global, local (by user country/ip) or friends (users invited through the app).

Other features can be implemented, such as a chat feature to permit chatting among players with options for canned messages and emojis; dynamic screen overlays; statistics feature showing various statistics include the worst hand to win in between game play rounds; and an ability to share game play information on various social media websites.

1. A system for operating a real-time, live simulcast online card game comprising:
a remote game server having memory for storing and applying instructions on how to operate the real-time, live simulcast online card game;
a live host;
an external commentator device for allowing the live host to provide live and simultaneous commentary on the progression of the card game; and
a plurality of external player devices for operatively allowing a plurality of players to play the card game,
wherein the live host is provided with real-time game play information and real-time player information for providing a real-time and a live interactive experience for the plurality of players.

2. The system of claim 1, wherein the memory further comprises a database containing historical player information.

3. The system of claim 1, wherein the external commentator device further comprises audio and video equipment for displaying real-time game play statistics.

4. The system of claim 1, wherein the external commentator device further comprises audio and video equipment for broadcasting live commentary.

5. The system of claim 1, wherein the instructions further comprises instructions for:
remotely connecting the game server to the external commentator device;
remotely connecting the game server to each of the external player devices;
receiving a request to participate in the game from the plurality of players;
reviewing each player request to participate in the game and accepting players to the game;
calculating a total number of players;
determining a total number of game tables required to accommodate all of the plurality of players;
randomly assigning accepted players to one of the plurality of game tables; and
initiating game play.

6. The system of claim 5, wherein for each game table, the instructions further comprises:
shuffling a deck of cards;
assigning at least one player card to each player at the game table, the player cards assigned to each player being visible to and applicable to that one player only;
assigning at least one community card to the house, the community card being visible and shared by all of the plurality of players across all of the plurality of game tables;
requesting each player to decide if they wish to continue game play;
accepting requests from each player to continue game play;
assigning subsequent community cards to the house;
determining a winning player at each game table.

7. The system of claim 6, wherein the instructions further comprises instructions to play subsequent rounds of game play, each round comprising of winning players from the previous round.

8. A real-time, live simulcast online card game comprises the steps of:
providing a remote game server for hosting the card game;
the game server connecting to a live host for providing live commentary during game play;
a plurality of interested players submitting a request to the game server to indicate their interest in game play;
the game server reviewing each of the plurality of interested players' request and accepting each of the plurality of interested players;
the game server calculating a total number of players and determining a total number of game tables required to accommodate all of the plurality of players accepted for game play;
the game server assigning each of the players accepted for game play to one of a plurality of game tables; and
the game server initiating game play.

9. The card game of claim 8, wherein initiating game play further comprises initiating a first round of game play for each game table of the plurality of game tables by:
shuffling a deck of cards;
assigning at least one card to each player;
assigning at least one community card to the house, the at least one community card visible to and shared by all of the plurality of players across all of the plurality of game tables;
each player determining if they wish to continue game play or not, and submitting a request to continue game play;
assigning subsequent community cards to the house; and
determining a winner of the game table by comparing the cards assigned to each player in combination with the community cards,
wherein the cards assigned to each player are not visible to any other player in that game table.

10. The card game of claim 8, wherein the live host is provided with real-time information regarding the community cards assigned to the house and provides simultaneous and live commentary on the community cards.

11. The card game of claim 8, wherein the live host is provided with real-time information regarding player information and provides simultaneous and live commentary regarding player information including information regarding players who have decided to continue game play.

12. The card game of claim 9, further comprising initiating a subsequent round of game play by:
determining the total number of game tables required based on the number of winning players in the first round of game play;
assigning each of the winning players of the first round of game play to a game table for the subsequent round of game play;
repeating the game play to determine a winning player for each of the game tables of the subsequent round.

13. The card game of claim 12, further comprising initiating a final round of game play by:
determining the total number of game tables required based on the number of winning players in the first round of game play;
assigning each of the winning players of the first round of game play to a game table for the subsequent round of game play;
repeating the game play to determine a final winning player.
